(19) United States
(12) Patent Application Publication
(10) Pub. No.: US 2023/0038693 A1
(43) Pub. Date: Feb. 9, 2023

(54) LIGHT SOURCE APPARATUS

(71) Applicant: Panasonic Holdings Corporation, Osaka (JP)

(72) Inventors: Kouji OOMORI, Shiga (JP); Akihiko ISHIBASHI, Osaka (JP)

(21) Appl. No.: 17/814,920

(22) Filed: Jul. 26, 2022

(30) Foreign Application Priority Data
Aug. 6, 2021 (JP) 2021-129570

(51) Int. Cl. F21V 29/503; F21V 29/56

(52) U.S. Cl. CPC F21V 29/503; F21V 29/56; F21Y 2115/30

(57) ABSTRACT

A light source apparatus includes: a base part; an anisotropic heat conductive sheet whose thermal conductivity in a surface direction is higher than a thermal conductivity in a thickness direction, the anisotropic heat conductive sheet including a first surface that makes contact with a surface of the base part; a laser diode module disposed at a second surface on a side opposite to the first surface in the anisotropic heat conductive sheet, and configured to emit laser light; and a cooling member disposed at the second surface and separated from the laser diode module, wherein a refrigerant flows inside the cooling member.

### CROSS REFERENCE TO RELATED APPLICATIONS

This application is entitled to and claims the benefit of Japanese Patent Application No. 2021-129570 filed on Aug. 6, 2021, the disclosure of which including the specification, drawings and abstract is incorporated herein by reference in its entirety.

### TECHNICAL FIELD

The present disclosure relates to a light source apparatus.

### BACKGROUND ART

PTL 1 discloses a light source apparatus including a base material including a raised portion in which fluid flows, a baseplate in which a part of a plate surface is in contact with the top surface of the raised portion, and a semiconductor laser disposed apart from the raised portion at another part of the plate surface of the baseplate. The baseplate is formed of an anisotropic heat conduction material whose thermal conductivity in the surface direction is higher than the thermal conductivity in the thickness direction. The output of the semiconductor laser is relatively high, and therefore the heating value of the semiconductor laser is relatively large. The heat generated at the semiconductor laser is transmitted to the raised portion, and in turn, the fluid, through the baseplate.

### CITATION LIST

### Patent Literature

PTL 1

Japanese Patent Application Laid-Open No. 2018-56498

### SUMMARY OF INVENTION

### Technical Problem

In the light source apparatus disclosed in PTL 1, the semiconductor laser is supported only at the raised portion through the baseplate. As such, the vibration generated by the flow of the fluid inside the raised portion is transmitted to the semiconductor laser through the baseplate. When the semiconductor laser vibrates, the optical axis of the laser light emitted from the semiconductor laser varies, and consequently the characteristics of the laser light change. When the characteristics of the laser light change, the desired characteristics of the laser light may not be achieved.

An object of the present disclosure is to achieve both the cooling of the laser diode module that emits laser light and stabilization of the characteristics of the laser light in the light source apparatus.

### Solution to Problem

A light source apparatus of an embodiment of the present disclosure includes: a base part; an anisotropic heat conductive sheet whose thermal conductivity in a surface direction is higher than a thermal conductivity in a thickness direction, the anisotropic heat conductive sheet including a first surface that makes contact with a surface of the base part; a laser diode module disposed at a second surface on a side opposite to the first surface in the anisotropic heat conductive sheet, and configured to emit laser light; and a cooling member disposed at the second surface and separated from the laser diode module. A refrigerant flows inside the cooling member.

### Advantageous Effects of Invention

With the light source apparatus of the present disclosure, it is possible to achieve both the cooling of the laser diode module that emits laser light and stabilization of the characteristics of the laser light.

### BRIEF DESCRIPTION OF DRAWINGS

FIG. 1 is a perspective view illustrating a light source apparatus according to a first embodiment of the present disclosure;

FIG. 2 is a sectional view taken along a line II-II in FIG. 1;

FIG. 3 is a perspective view of a base part and an anisotropic heat conductive sheet;

FIG. 4 is a perspective view of a light source apparatus according to a second embodiment of the present disclosure;

FIG. 5 is a perspective view of a base part and an anisotropic heat conductive sheet;

FIG. 6 is a perspective view of an electrode of a light source apparatus according to a third embodiment of the present disclosure; and

FIG. 7 is an exploded perspective view of an electrode.

### DESCRIPTION OF EMBODIMENTS

### First Embodiment

A light source apparatus according to a first embodiment of the present disclosure is described below with reference to the drawings.

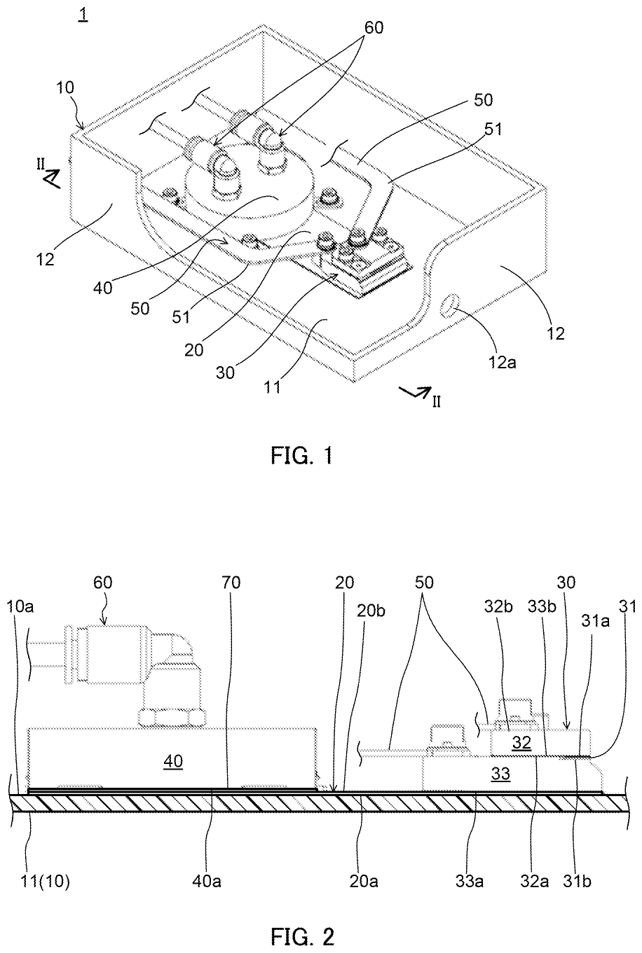

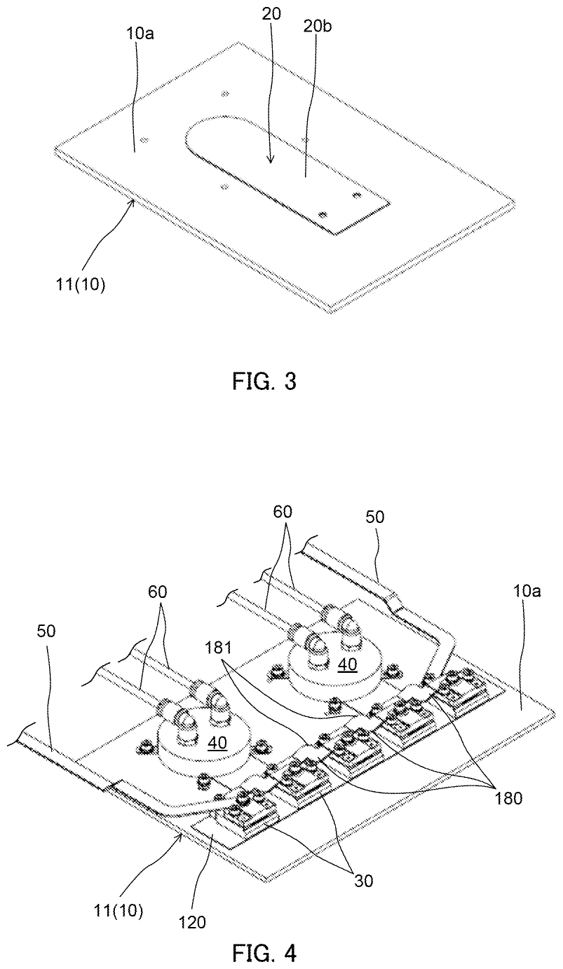

As illustrated in FIGS. 1 to 3, light source apparatus 1 includes base part 10, anisotropic heat conductive sheet 20, laser diode module 30, and cooling member 40.

Base part 10 includes bottom plate 11 and side plate 12 provided at the periphery of bottom plate 11. Side plate 12 includes hole 12a through which laser light described later passes. Base part 10 is formed with an electrically insulating material. The material of base part 10 is resin, for example.

Anisotropic heat conductive sheet 20 is a sheet whose thermal conductivity in the surface direction is higher than the thermal conductivity in the thickness direction. Anisotropic heat conductive sheet 20 is formed of graphite. In anisotropic heat conductive sheet 20, the thermal conductivity in the surface direction is higher than the thermal conductivity in the thickness direction due to the aligned orientation of the graphite particles. Note that anisotropic heat conductive sheet 20 may be composed of a composite material of graphite and a metal material such as copper and aluminum. Anisotropic heat conductive sheet 20 has conductivity.

Anisotropic heat conductive sheet 20 is formed in a belt shape, but it goes without saying that the belt shape is not limitative. Anisotropic heat conductive sheet 20 is in contact with surface 10a of base part 10 at first surface 20a. Specifically, surface 10a of base part 10 is a flat bottom surface provided in base part 10 (more specifically, a plate surface of bottom plate 11). The entire first surface 20a of anisotropic heat conductive sheet 20 is in contact with the bottom surface of base part 10. In this manner, the rigidity of anisotropic heat conductive sheet 20 may be reduced, and the thickness of anisotropic heat conductive sheet 20 can be relatively reduced. More specifically, the thickness of anisotropic heat conductive sheet 20 is 0.1 mm to 1 mm.

Laser diode module 30 is disposed at second surface 20b on the side opposite to first surface 20a in anisotropic heat conductive sheet 20, and configured to emit laser light. Laser diode module 30 includes semiconductor element 31, and two conductive members 32 and 33.

Semiconductor element 31 emits laser light. Semiconductor element 31 has a plate shape. Semiconductor element 31 includes a plurality of emitters with a P-type electrode and an N-type electrode (not illustrated in the drawing). The P-type electrode is provided at plate surface 31a, which is one of the plate surfaces of semiconductor element 31. The N-type electrode is provided at plate surface 31b on the side opposite to the one plate surface in semiconductor element 31. When a voltage is applied between the P-type electrode and the N-type electrode and a current flows therethrough, laser light is emitted from the emitter.

Two conductive members 32 and 33 supply a current to semiconductor element 31. Two conductive members 32 and 33 are composed of a conductive material and have a cuboid shape larger than semiconductor element 31. In addition, the volume of second conductive member 33 is larger than the volume of first conductive member 32. Note that two conductive members 32 and 33 may have the same volume, or the volume of first conductive member 32 may be greater than the volume of second conductive member 33. Two conductive members 32 and 33 are formed of a metal material such as copper with a relatively high thermal conductivity.

Two conductive members 32 and 33 sandwich semiconductor element 31. First conductive member 32 is electrically connected with the P-type electrode of the emitter, at bottom surface 32a. Second conductive member 33 is electrically connected with the N-type electrode of the emitter, at top surface 33b. In addition, to prevent direct contact between two conductive members 32 and 33, an electrically insulating sheet (not illustrated in the drawing) formed of aluminum nitride is disposed between two conductive members 32 and 33, for example.

Second conductive member 33 is disposed at second surface 20b of anisotropic heat conductive sheet 20. The entire bottom surface 33a of second conductive member 33 is in contact with second surface 20b. In addition, electrode 50 is attached at top surfaces 32b and 33b of two conductive members 32 and 33.

Electrode 50 is connected to a power source (not illustrated in the drawing) disposed outside base part 10. Electrode 50 is formed in a belt shape with a metal material such as copper with conductivity. In addition, electrode 50 includes at least one bent part 51. Electrode 50 is bent at bent part 51, and thus electrode 50 can be disposed by avoiding cooling member 40 and the like. In this manner, the degree of freedom of the layout of laser diode module 30 and cooling member 40 can be improved. Note that electrode 50 need not necessarily include bent part 51.

When the power is supplied to semiconductor element 31 from the power source through electrode 50 and two conductive members 32 and 33 and a current flows through semiconductor element 31, laser light is emitted from semiconductor element 31. The laser light passes through hole 12a, and is then emitted to the outside of base part 10. In addition, at this time, the temperature of semiconductor element 31 increases due to the heat generation of semiconductor element 31.

Cooling member 40 cools a member touching the exterior surface. Cooling member 40 is formed in a circular columnar shape with a metal material such as copper and aluminum with a relatively high thermal conductivity. It goes without saying that the shape of cooling member 40 is not limited to the circular columnar shape. Cooling member 40 includes a channel (not illustrated in the drawing) in which refrigerant flows.

The channel is connected to a cooling device (not illustrated in the drawing) disposed outside base part 10 through pipe 60. The cooling device is a radiator, for example. The refrigerant circulates between cooling member 40 and the cooling device through pipe 60, and is cooled by the cooling device. The refrigerant is, for example, water, but it may be alcohol. In the case where the refrigerant is alcohol, cooling member 40 or the cooling device can perform cooling using heat of vaporization.

Cooling member 40 is disposed at second surface 20b of anisotropic heat conductive sheet 20, and separated away from laser diode module 30. The distance between cooling member 40 and laser diode module 30 is a distance with which the transmission, to laser diode module 30, of the vibration of the refrigerant flowing through cooling member 40 can be suppressed. A part of bottom surface 40a of cooling member 40 is in contact with second surface 20b. Note that all of bottom surface 40a of cooling member 40 may be in contact with second surface 20b.

In addition, light source apparatus 1 further includes insulating member 70 with an electrically insulating property. Insulating member 70 is formed in a sheet shape with aluminum nitride, for example. Insulating member 70 is disposed between anisotropic heat conductive sheet 20 and cooling member 40. That is, cooling member 40 is disposed at anisotropic heat conductive sheet 20 through insulating member 70. When the power of semiconductor element 31 is supplied, insulating member 70 can prevent a current from flowing through laser diode module 30, anisotropic heat conductive sheet 20 and in turn the refrigerant flowing through cooling member 40.

Note that insulating member 70 may be disposed between anisotropic heat conductive sheet 20 and laser diode module 30, instead of between anisotropic heat conductive sheet 20 and cooling member 40. In addition, insulating member 70 may be disposed between anisotropic heat conductive sheet 20 and cooling member 40, and between anisotropic heat conductive sheet 20 and laser diode module 30.

Next, the cooling of semiconductor element 31 in light source apparatus 1 is described.

The heat generated at semiconductor element 31 is transmitted to two conductive members 32 and 33. That is, two conductive members 32 and 33 have a function of a heat sink. Since the volume of second conductive member 33 is larger than the volume of first conductive member 32, the heat value transmitted to second conductive member 33 is greater than the heat value of transmitted to first conductive member 32. The heat transmitted to second conductive member 33 is transmitted to anisotropic heat conductive sheet 20.

As described above, in anisotropic heat conductive sheet 20, the thermal conductivity in the surface direction is higher than the thermal conductivity in the thickness direction. In this manner, the most part of the heat transmitted to anisotropic heat conductive sheet 20 is transmitted along second surface 20b of anisotropic heat conductive sheet 20. The heat transmitted along second surface 20b of anisotropic heat conductive sheet 20 is transmitted to cooling member 40, and collected by the refrigerant.

As described above, by using anisotropic heat conductive sheet 20, semiconductor element 31 can be reliably cooled even when cooling member 40 and laser diode module 30 provided with semiconductor element 31 are separated from each other. In addition, with laser diode module 30 and cooling member 40 separated from each other, the transmission of the vibration generated by the flow of the refrigerant to semiconductor element 31 can be suppressed. In this manner, both the cooling of laser diode module 30 and the stabilization of the characteristics of the laser light can be achieved. Thus, desired laser light characteristics can be reliably obtained.

In addition, semiconductor element 31 is cooled, even with base part 10 not having the function of cooling semiconductor element 31. In this manner, base part 10 need not include a channel through which refrigerant flows for cooling semiconductor element 31. In this manner, the shape of base part 10 can be simplified. In addition, a material other than a metal material with a relatively high thermal conductivity may be selected as the material of base part 10, and an electrically insulating material may be selected as described above. In this manner, an electrically insulating member need not be disposed between base part 10 and laser diode module 30.

In addition, as described above, base part 10 is formed of a resin material. In this manner, the weight can be reduced in comparison with the case where base part 10 is formed of a metal material. Note that while base part 10 is formed to include bottom plate 11 and side plate 12, this is not limitative, and it suffices that base part 10 is formed to include a surface where anisotropic heat conductive sheet 20 makes contact. In addition, base part 10 may be formed of a conductive material.

In addition, cooling member 40 may be formed of an electrically insulating material. In this case, light source apparatus 1 need not include insulating member 70.

### Second Embodiment

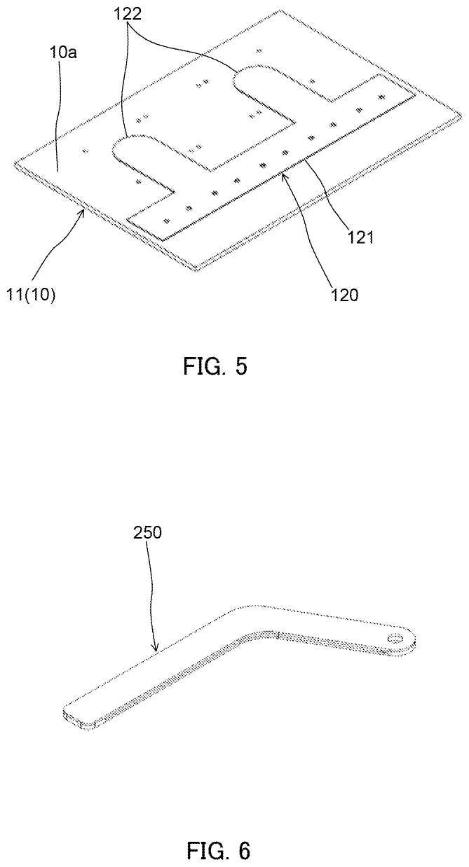

Next, a light source apparatus according to a second embodiment of the present disclosure is described with reference to FIGS. 4 and 5 mainly regarding differences from the first embodiment.

Anisotropic heat conductive sheet 120 of the second embodiment includes belt-shaped part 121 and two branches 122 branching from belt-shaped part 121.

In addition, light source apparatus 1 of the second embodiment includes a plurality of laser diode modules 30 or a plurality of cooling members 40. Light source apparatus 1 of the second embodiment includes five laser diode modules 30 and two cooling members 40, but but it goes without saying that these numbers are not limitative.

Five laser diode modules 30 are disposed in a line at belt-shaped part 121. Five laser diode modules 30 are electrically connected in series through electrode 50 and second electrode 180. Second electrode 180 includes at least one bent part 181. In this manner, the degree of freedom of the layout of the plurality of laser diode modules 30 can be improved. Note that second electrode 180 need not include bent part 181.

Electrode 50 is attached to laser diode module 30 disposed at both ends. Second electrode 180 is disposed to connect laser diode modules 30 adjacent to each other.

Two cooling members 40 are respectively disposed at two branches 122 and separated away from a plurality of laser diode modules 30.

The heat generated at semiconductor element 31 of each of five laser diode modules 30 is transmitted to at least one cooling member 40 of two cooling members 40 through anisotropic heat conductive sheet 120, and thus semiconductor element 31 is cooled. It goes without saying that the shape of anisotropic heat conductive sheet 120, and the layout of the plurality of laser diode modules 30 and the plurality of cooling members 40 are not limited to the illustration in FIGS. 4 and 5.

### Third Embodiment

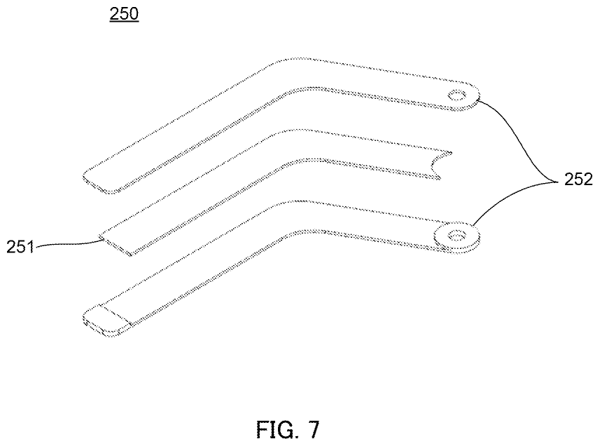

Next, a light source apparatus according to a third embodiment of the present disclosure is described with reference to FIGS. 6 and 7 mainly regarding differences from the first embodiment.

In light source apparatus 1 of the third embodiment, electrode 250 includes second anisotropic heat conductive sheet 251. Second anisotropic heat conductive sheet 251 is formed in a belt shape and provided such that the thermal conductivity in the surface direction is higher than the thermal conductivity in the thickness direction, as in the above-mentioned anisotropic heat conductive sheet 20.

In electrode 250, second anisotropic heat conductive sheet 251 is sandwiched by two conductive sheets 252. Conductive sheet 252 is formed in a belt shape with a metal material such as copper with conductivity. In addition, electrode 250 is connected with a heat sink (not illustrated in the drawing) outside base part 10, for example.

The heat transmitted from semiconductor element 31 to first conductive member 32 is transmitted to electrode 250, and emitted to the outside of base part 10. In comparison with the case where electrode 250 does not include second anisotropic heat conductive sheet 251, the heat value emitted to the outside of base part 10 can be increased.

Note that it goes without saying that the number of second anisotropic heat conductive sheet 251 is not limited to one, and that the number of conductive sheet 252 is not limited to two. In addition, second anisotropic heat conductive sheet 251 may be fixed by being bonded to conductive sheet 252.

The present disclosure is not limited to the above-described aspects. As long as the main purpose of this disclosure is not departed from, various modifications to this embodiment and embodiments implemented by combining components in different embodiments are also included within the scope of this disclosure.

### INDUSTRIAL APPLICABILITY

The present invention is widely applicable to light source apparatuses.

### REFERENCE SIGNS LIST

1 Light source apparatus
10 Base part
10a Surface
20 Anisotropic heat conductive sheet
20a First surface
20b Second surface
30 Laser diode module
31 Semiconductor element
32 First conductive member
33 Second conductive member
40 Cooling member
50 Electrode
70 Insulating member
251 Second anisotropic heat conductive sheet

1. A light source apparatus comprising:
a base part;
an anisotropic heat conductive sheet whose thermal conductivity in a surface direction is higher than a thermal conductivity in a thickness direction, the anisotropic heat conductive sheet including a first surface that makes contact with a surface of the base part;
a laser diode module disposed at a second surface on a side opposite to the first surface in the anisotropic heat conductive sheet, and configured to emit laser light; and
a cooling member disposed at the second surface and separated from the laser diode module, wherein a refrigerant flows inside the cooling member.

2. The light source apparatus according to claim 1, further comprising a plurality of the laser diode modules or a plurality of the cooling members.

3. The light source apparatus according to claim 1, further comprising an insulating member disposed between the anisotropic heat conductive sheet and the cooling member, or between the anisotropic heat conductive sheet and the laser diode module, the insulating member being electrically insulating.

4. The light source apparatus according to claim 1,
wherein the laser diode module includes a semiconductor element configured to emit the laser light when a current flows, and two conductive members to which an electrode is attached, the two conductive members being configured to supply a current to the semiconductor element; and
wherein one of the two conductive members is in contact with the second surface.

5. The light source apparatus according to claim 4, wherein the electrode includes a second anisotropic heat conductive sheet whose thermal conductivity in a surface direction is higher than a thermal conductivity in a thickness direction.

6. The light source apparatus according to claim 1, wherein the base part is formed of an electrically insulating material.

7. The light source apparatus according to claim 1, wherein a thickness of the anisotropic heat conductive sheet is 0.1 mm to 1 mm.
